(19) United States
(12) Patent Application Publication
(10) Pub. No.: US 2005/0161905 A1
(43) Pub. Date: Jul. 28, 2005

(54) Hydraulic drive line and hitching assembly for pull-type implement

(75) Inventors: Jean-Marie Chalancon, Ottersthal (FR); Ligouy Jean-Baptiste, Cerdon (FR); Fabien Deschang, Mittelbronn (FR)

Correspondence Address: OBLON, SPIVAK, MCCLELLAND, MAIER & NEUSTADT, P.C., 1940 DUKE STREET, ALEXANDRIA, VA, 22314, US

(73) Assignee: KUHN S.A., SAVERNE CEDEX (FR)

(21) Appl. No.: 10/506,988

(22) PCT Filed: Mar. 10, 2003
(86) PCT No.: PCT/FR03/00757

(30) Foreign Application Priority Data
Mar. 11, 2002 (FR) 0203098

(51) Int. Cl. B60D 1/00

(52) U.S. Cl. 280/494

(57) ABSTRACT

An agricultural machine including a body that at least partially rests on the ground. The body can be hitched to a tractor vehicle by at least one link defining a first pivoting axle directed upwards; a second pivoting axle that is substantially horizontal is directed according to a direction of advancement of the agricultural machine, and a third pivoting axis that is substantially horizontal is directed across the direction of advancement. The agricultural machine also includes an adapter firmly connected to a hitch bar of the tractor vehicle, a support axle, and at least one jaw including an opening that widens according to a substantially vertical direction. During hitching, the support axle is engaged inside the jaw.

The present invention relates to the general technical field of agricultural machinery. More particularly it concerns an agricultural machine comprising a body resting at least partially on the ground, said body is intended to be hitched to a tractor vehicle by means of at least one articulation defining a first pivoting axis directed upward, a second substantially horizontal pivoting axis directed in a direction of travel of said agricultural machine, and a third substantially horizontal pivoting axis directed transversely to said direction of travel.

Document EP 0 823 984 describes a mower intended to be hitched to a tractor vehicle. This known mower comprises a primary hitch bar, a connection device, and a secondary hitch bar. Said connection device is connected in pivoting manner to said primary hitch bar by means of an articulation defining a first axis directed upward. For its part, said secondary hitch bar is connected in pivoting manner to said connection device by means of an articulation defining a second substantially horizontal axis directed in a direction of travel of said mower. In document EP 0 823 984, said secondary hitch bar is intended to be hitched to a drawbar of said tractor vehicle. To do this, an adapter is mounted rigidly on said drawbar and defines with said secondary hitch bar an articulation pivoting along a third substantially horizontal axis directed transversely to a direction of travel of said mower.

The connection device described in this prior document however has one major drawback. Specifically, the articulation along said third axis is achieved by means of a pin passing through two coaxial holes of said adapter and two coaxial holes of said secondary hitch bar. Thus, at the time of hitching, the user must first approach and extremely accurately line up said tractor vehicle and said mower and then, where appropriate, operate a telescopic stand in order to bring the front of said mower and therefore the coaxial holes of said secondary hitch bar to the exact height of the coaxial holes of said adapter, and finally insert said pin through said holes. In practice, the precise alignment of the tractor vehicle and said mower is difficult to achieve. The user must therefore often make several attempts before being able to hitch this known mower.

Through document FR 1 460 750, those skilled in the art are conversant with a hitching system for hitching an agricultural machine to a tractor. This hitching system comprises a transverse cylindrical bar whose ends are connected respectively to the ends of the two lower arms of a “three point” hitch of said tractor. This system also comprises a horizontal crossbar arranged at the front of said machine and fitted with two yokes. Each yoke is provided with a respective opening widening out downward. During hitching, the user brings said tractor close to said machine in order to position said cylindrical bar beneath said openings. Then, by slightly lifting two lower arms of said “three point” hitch, said cylindrical bar automatically engages in the two yokes in order to connect said agricultural machine to said tractor.

The aim of the present invention is to obtain an agricultural machine that can be easily hitched to a drawbar of a tractor vehicle.

Accordingly, the agricultural machine according to the present invention is characterized in that it also comprises an adapter intended to be rigidly connected to a drawbar of said tractor vehicle, a support spindle, and at least one jaw comprising an opening widening out in a substantially vertical direction, such that, during hitching, said support spindle is intended to engage in said jaw.

The use of said support spindle and of said at least one jaw allows said tractor vehicle and said agricultural machine to be approximately aligned to achieve the hitching, hence a great simplification of the operation.

Other features of the invention, to be considered separately or in all their possible combinations, will further be revealed in the following description of a nonlimiting embodiment of the invention shown in the appended drawings in which:

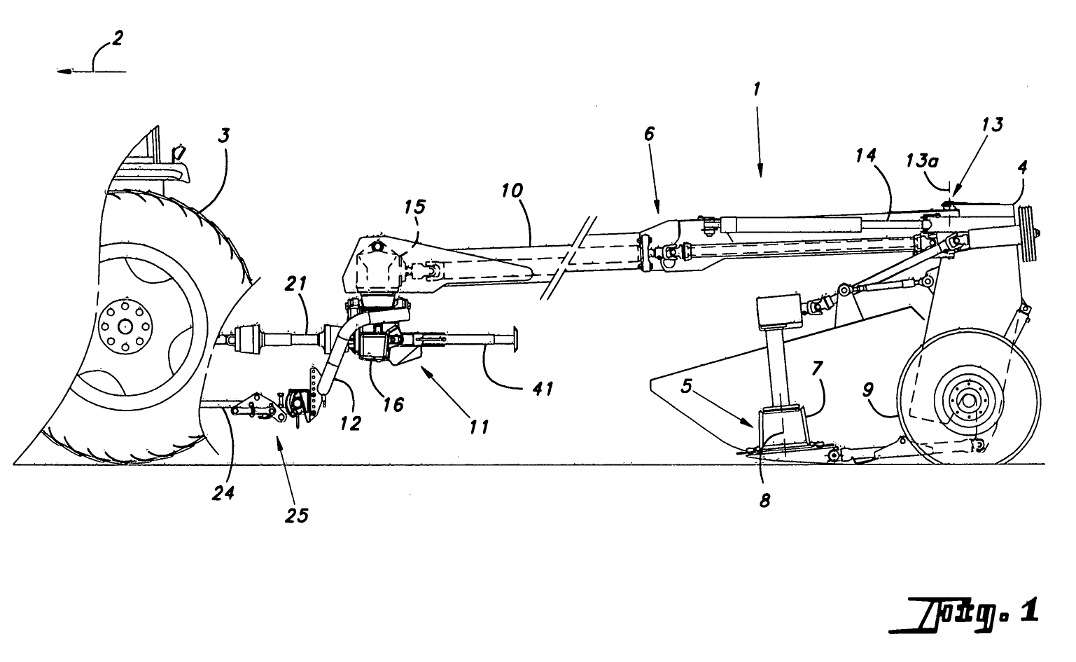

FIG. 1 represents, in side view, an agricultural machine according to the present invention hitched to a tractor vehicle,

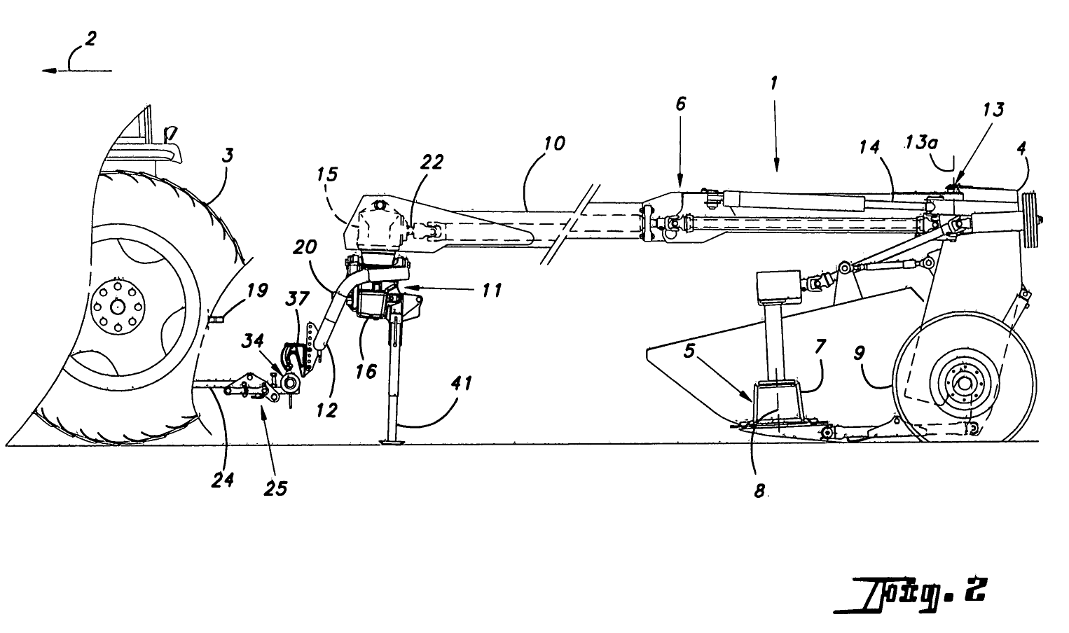

FIG. 2 represents, in side view, said agricultural machine unhitched from said tractor vehicle,

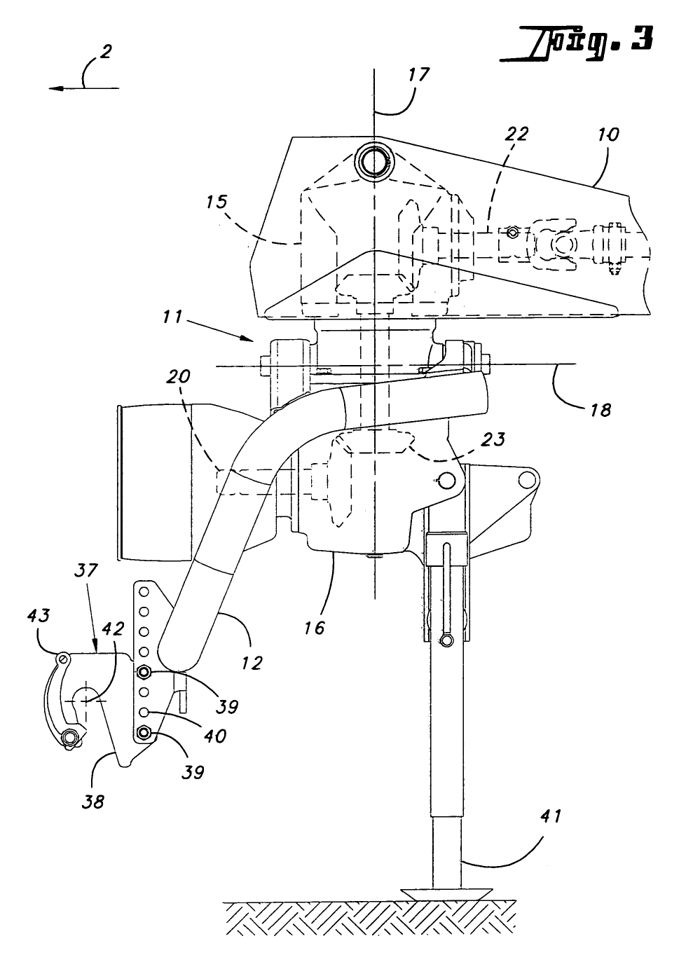

FIG. 3 represents, in side view and on another scale, a front portion of the hitch bar of said agricultural machine,

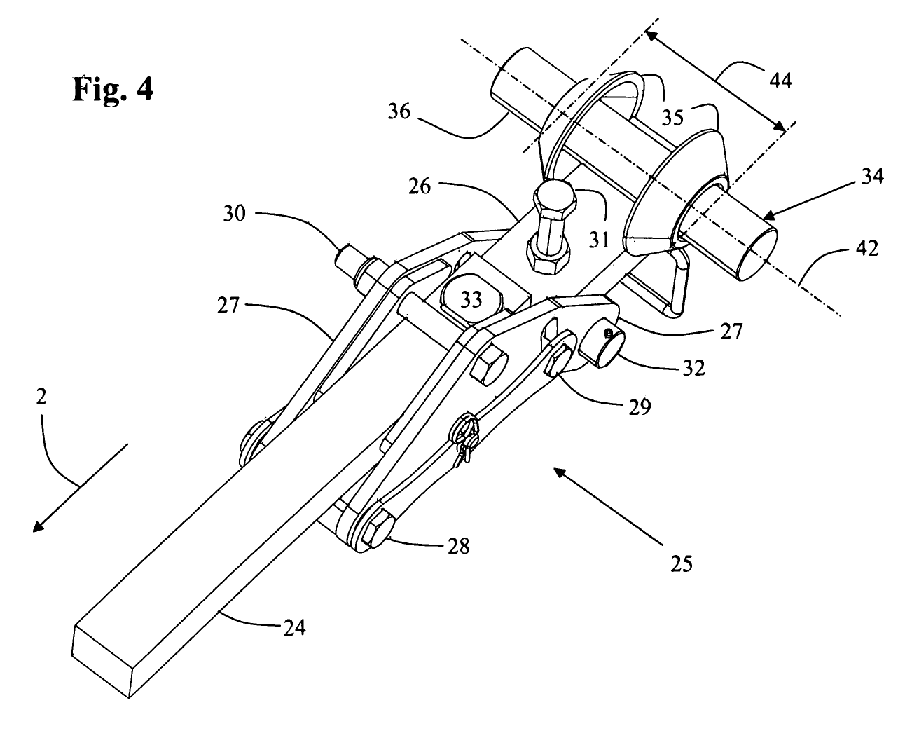

FIG. 4 represents, in perspective view and on another scale, an adapter of said agricultural machine,

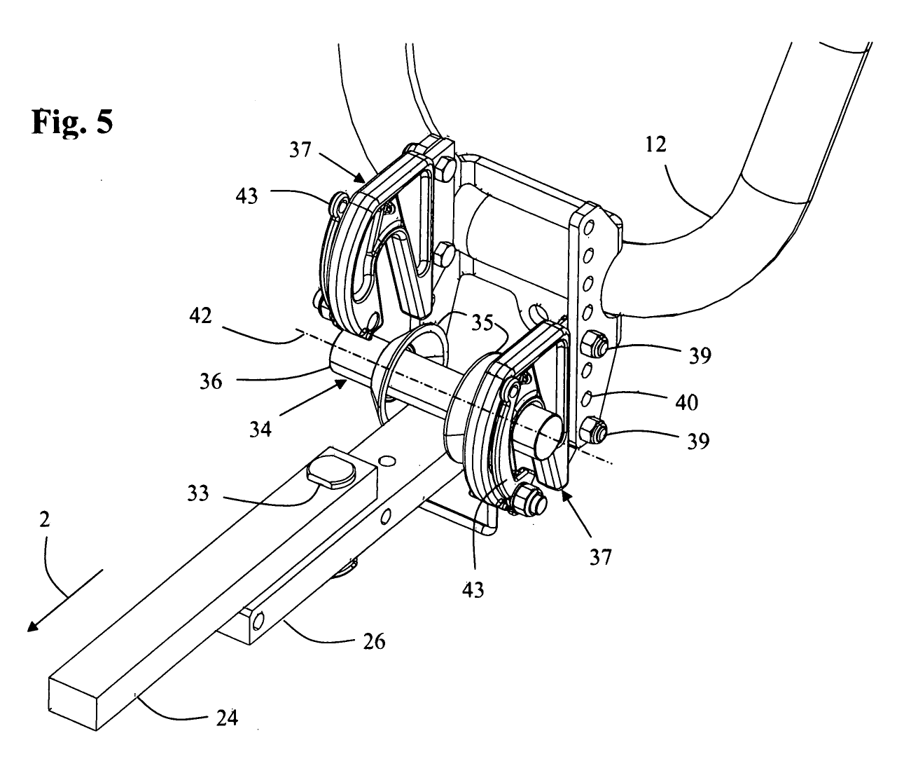

FIG. 5 represents, in perspective view and on another scale, the support spindle engaged with a jaw.

FIG. 1 represents, in side view, an agricultural machine (1) pulled by a tractor vehicle (3) in a direction of travel indicated by the arrow (2). In the remainder of the description, the following notions “forward” and “backward”, “front” and “rear” are defined in relation to the direction of travel (2) and the notions “right” and “left” are defined when looking at said agricultural machine (1) from the rear in the direction of travel (2).

In the light of FIGS. 1 and 2, said agricultural machine (1) comprises a body (4) resting at least partially on the ground by means of wheels (9). In the exemplary embodiment shown, said body (4) is fitted with working units (5) driven from a power take-off (19) of said tractor vehicle (3). Said power take-off (19) has been shown in FIG. 2.

Said agricultural machine (1) also comprises a hitch bar (6) intended to connect said body (4) to said tractor vehicle (3). Said hitch bar (6) consists of a primary hitch bar (10), a connection and transmission device (11) and a secondary hitch bar (12).

Said primary hitch bar (10) is connected to said body (4) by means of an articulation (13) of axis (13a) directed upward. Accordingly, said hitch bar (6) may advantageously occupy at least one working position and one transport position. The pivoting of said hitch bar (6) around said articulation (13) is performed by means of a hydraulic jack (14). According to another embodiment not shown, said primary hitch bar (10) is rigidly connected to said body (4). In order to have an overview of said agricultural machine (1), said primary hitch bar (10) has not been shown in its entirety in FIGS. 1 and 2.

For its part, said connection and transmission device (11) comprises a first gearbox (15) and a second gearbox (16). With more particular reference to FIG. 3, said first gearbox (15) is rigidly connected to a front portion of said primary hitch bar (10). In turn, said second gearbox (16) is connected in pivoting manner to said first gearbox (15) by means of an articulation defining a first axis (17) directed upward. Said axis (17) is advantageously vertical.

In addition to its involvement in the hitching of said agricultural machine (1), said connection and transmission device (11) is also involved in driving said working units (5) from said power take-off (19). Accordingly, said second gearbox (16) comprises an input shaft (20). Said input shaft (20), represented in FIGS. 2 and 3, is oriented at least substantially in said direction of travel (2). In the light of FIG. 1, said input shaft (20) is intended to be connected to said power take-off (19) by means of a telescopic transmission shaft with universal joints (21). In the exemplary embodiment represented in FIG. 3, said input shaft (20) of the second gearbox (16) then drives an output shaft (22) of said first gearbox (15) in rotation via an intermediate shaft (23). Said intermediate shaft is advantageously coaxial with said first axis (17) directed upward. For its part, said output shaft (22) is directed rearward at least substantially along a longitudinal axis of said primary hitch bar (10). Finally, said output shaft (22) is connected to said working units (5) by transmission elements known to those skilled in the art. Thus, in a particularly advantageous manner, said working units (5) are driven from said power take-off (19) irrespective of the position of said agricultural machine (1) relative to said tractor vehicle (3).

Said secondary hitch bar (12) is connected in pivoting manner to said second gearbox (16) by means of an articulation defining a second substantially horizontal axis (18) directed in said direction of travel (2). In the light of FIG. 3, said second axis (18) is advantageously arranged between said input shaft (20) and said output shaft (22). Preferably, said second axis (18) intersects said first axis (17).

For more details concerning the implementation of said connection and transmission device (11), the implementation of the articulation along said first axis (17), and/or the implementation of the articulation along said second axis (18), those skilled in the art may if necessary refer to document FR 2 712 764.

As can be seen in FIG. 1, said secondary hitch bar (12) is intended to be hitched to a drawbar (24) of said tractor vehicle (3). In a manner known by those skilled in the art, said drawbar (24) is an accessory of said tractor vehicle (3) rigidly connected to the latter. When said drawbar (24) is mounted, it is arranged at least substantially horizontally in a vertical mid-plane of said tractor vehicle (3). A rear end of said drawbar (24) comprises at least one vertical hole intended to receive a pin (33).

Since the gage of said drawbar (24) may vary according to the brand and power category of said tractor vehicle (3), said agricultural machine (1) according to the present invention advantageously comprises an adapter (25) intended to be rigidly connected to said drawbar (24). Thus, in the exemplary embodiment represented in FIG. 4, said adapter (25) notably comprises two side plates (27) mounted respectively on either side of an intermediate bar (26) by means of two mounting rods (28, 29). One of said two mounting rods (28) also serves as an axis for the pivoting of said intermediate bar (26) relative to said side plates (27). Advantageously, by tightening said two mounting rods (28, 29), said side plates (27) clamp said drawbar (24) laterally. Also provided is a locking rod (30) connected to said two side plates (27) and a tightening screw (31) connected to said intermediate bar (26). Said tightening screw (31) is intended to press against a pin (32) secured to said side plates (27). By tightening said tightening screw (31), said drawbar (24) is advantageously clamped between said locking rod (30) and said intermediate bar (26). Said adapter (25) may thus be rigidly connected without mechanical play irrespective of the gage of said drawbar (24).

Preferably, said intermediate bar (26) also comprises a vertical hole intended to receive said pin (33). By thus passing through said drawbar (24) and said intermediate bar (26), said pin (33) advantageously makes it possible to transmit the traction forces from one to the other. For greater detail concerning this exemplary embodiment of said adapter (25), those skilled in the art may if necessary refer to document EP 1 051 894.

To hitch said secondary hitch bar (12) to said drawbar (24), said agricultural machine (1) also comprises a support spindle (34) and at least one jaw (37). At the time of hitching, said support spindle (34) is intended to engage in said jaw (37). Preferably, when hitching, said support spindle (34) and said jaw (37) constitute an articulation pivoting along a third substantially horizontal axis (42) directed transversely to said direction of travel (2).

In the exemplary embodiment shown in the figures, said support spindle (34) is rigidly connected to a rear portion of said intermediate bar (26). Said support spindle (34) is also arranged transversely to said direction of travel (2). As shown more particularly in FIGS. 4 and 5, said support spindle (34) advantageously comprises a cylinder (36) arranged above said intermediate bar (26) and at least one centering element (35) intended in particular to guide said jaw (37) during hitching. Accordingly, said centering element (35) has a frustoconical shape centered on said cylinder (36). For its part, said jaw (37) is rigidly connected to said secondary hitch bar (12). In the light of FIG. 3 in particular, said jaw (37) advantageously comprises an opening (38) directed downward. To produce the articulation along said third axis (42), said cylinder (36) rests on the bottom of said opening (38). The bottom of said opening (38) therefore advantageously has a rounded shape of a diameter substantially equal to that of said cylinder (36). Preferably, the entrance of said opening (38) is wider than the diameter of said cylinder (36) in order to facilitate the engagement of said support spindle (34) in said jaw (37).

In the exemplary embodiment shown in the figures, said agricultural machine (1) comprises two jaws (37). Said jaws (37) are arranged symmetrically on either side of a vertical mid-plane of said secondary hitch bar (12). For its part, said support spindle (34) comprises two centering elements (35) arranged symmetrically on either side of said intermediate bar (26). In the light of FIGS. 4 and 5, the vertex of the frustoconical shape of each centering element (35) is advantageously oriented toward a respective end of said cylinder (36).

Preferably, each jaw (37) is rigidly connected but in a manner adjustable in height relative to said secondary hitch bar (12). Thus, in FIG. 5, said jaw (37) shown on the left occupies a high position whereas said jaw (37) shown on the right occupies a low position. Accordingly, in the exemplary embodiment shown, said secondary hitch bar (12) comprises a plate drilled with vertically distributed holes (40). Said holes (40) are intended to receive bolts (39) connecting said jaws (37) to said secondary hitch bar (12). FIG. 5 is merely an illustration of the adjustment possibility; it goes without saying that in reality said jaws (37) are arranged at the same height. Also in said FIG. 5, many elements constituting said adapter (25) have not been shown for reasons of clarity.

To hitch the agricultural machine (1) according to the present invention, the user proceeds as follows.

After having rigidly connected said adapter (25) to said drawbar (24), the user reverses said tractor vehicle (3) such as to place said support spindle (34) beneath said jaws (37). In the light of FIG. 2, the user then operates a telescopic stand (41) in order to lower the front of said agricultural machine (1). So doing, said cylinder (36) engages in said openings (38) and finally said jaws (37) rest on said support spindle (34). As shown in FIG. 1, the user may now fold away said stand (41) and couple said transmission shaft (21) to said input shaft (20) and to said power take-off (19).

During hitching and particularly advantageously, the weight of said agricultural machine (1) will, if necessary, cause said jaws (37) to slide along the frustoconical shape of said centering elements (35). As a result, any transverse offset of said drawbar (24) relative to said secondary hitch bar (12) will be automatically cancelled out.

In addition, the larger entrance of said openings (38) allows said agricultural machine (1) to be hitched despite any possible longitudinal offset of said support spindle (34) relative to said jaws (37).

Preferably, the distance (44) separating the outer faces of said centering elements (35) is substantially equal to the distance separating said jaws (37). When said agricultural machine (1) is hitched, the transverse play between said secondary hitch bar (12) and said drawbar (24) is thus minimal.

In addition, said distance (44) separating the outer faces of said centering elements (35) and hence said distance separating said jaws (37) are preferably reduced to their most. Accordingly, the base of each centering element (35) is advantageously placed beside said intermediate bar (26). As a result, during hitching, any angular offset seen in a horizontal plane between a longitudinal axis of said drawbar (24) and the vertical mid-plane of said secondary hitch bar (12) generates only a slight longitudinal offset of said support spindle (34) relative to said jaws (37). The larger entry of said openings (38) also makes it possible to compensate for this slight longitudinal offset.

Consequently, even with said tractor vehicle (3) achieving an approximate approach and alignment, the user can hitch the agricultural machine (1) according to the present invention.

Advantageously, each jaw (37) also comprises a bolt (43) at least partially obstructing said opening (38). Said bolt (43) thus prevents said support spindle (34) from accidentally coming out of said jaw (37). During hitching, said bolts (43) withdraw preferably automatically to allow said support spindle (34) to pass.

The agricultural machine that has just been described, is merely an exemplary embodiment which in no circumstances would limit the scope of protection defined by the following claims.

Specifically, in another exemplary embodiment not shown, said support spindle (34) is connected rigidly and adjustably in height to said secondary hitch bar (12). For its part, said at least one jaw (37) is rigidly connected to said adapter (25). In addition, said at least one jaw (37) in this instance comprises an opening (38) widening out upward.

As a nonlimiting example, said agricultural machine (1) has been shown as a mower. Thus said working units (5) consist in particular of cutting disks (7) driven in rotation around a respective axis (8) directed upward.

1-14. (canceled)

15. An agricultural machine comprising:
a body resting at least partially on the ground, the body configured to be hitched to a tractor vehicle by at least one articulation defining:
a first pivoting axis directed upward,
a second substantially horizontal pivoting axis directed in a direction of travel of the agricultural machine, and
a third substantially horizontal pivoting axis directed transversely to the direction of travel;
an adapter configured to be rigidly connected to a drawbar of the tractor vehicle;
a support spindle; and
at least one jaw comprising an opening widening out in a substantially vertical direction, wherein during hitching the support spindle is configured to engage in the at least one jaw.

16. An agricultural machine as claimed in claim 15, further comprising a primary hitch bar connected to the body and a secondary hitch bar connected to the primary hitch bar.

17. An agricultural machine as claimed in claim 16, wherein the secondary hitch bar is connected in a pivoting manner to the primary hitch bar by an articulation defining the first pivoting axis directed upward.

18. An agricultural machine as claimed in claim 16, wherein the secondary hitch bar is connected in a pivoting manner to the primary hitch bar by an articulation defining the second substantially horizontal pivoting axis directed in a direction of travel.

19. An agricultural machine as claimed in claim 16, further comprising a connection and transmission device configured to connect the secondary hitch bar to the primary hitch bar and by which working units of the body are driven from a power take-off of the tractor vehicle.

20. An agricultural machine as claimed in claim 19, wherein the connection and transmission device comprises:
a first gearbox rigidly connected to a front portion of the primary hitch bar; and
a second gearbox connected in a pivoting manner to the first gearbox by an articulation defining the first pivoting axis directed upward,
wherein said secondary hitch bar is connected in a pivoting manner to the second gearbox by an articulation defining the second substantially horizontal pivoting axis directed in a direction of travel.

21. An agricultural machine as claimed in claim 16, wherein:
the support spindle is rigidly connected to the adapter,
the at least one jaw is rigidly connected to the secondary hitch bar, and
the opening widens out downward.

22. An agricultural machine as claimed in claim 21, wherein the at least one jaw is connected in a manner adjustable in height relative to the secondary hitch bar.

23. An agricultural machine as claimed in claim 21, comprising two jaws arranged symmetrically on either side of a vertical mid-plane of the secondary hitch bar.

24. An agricultural machine as claimed in claim 23, wherein the support spindle comprises a cylinder and at least one centering element centered on the cylinder, the centering element having a frustoconical shape whose vertex is oriented toward one end of the cylinder.

25. An agricultural machine as claimed in claim 24, wherein the support spindle comprises two centering elements, a distance separating outer faces of the two centering elements being substantially equal to a distance separating the two jaws.

26. An agricultural machine as claimed in claim 25, wherein the adapter comprises an intermediate bar and the centering elements are placed beside on either side of the intermediate bar.

27. An agricultural machine as claimed in claim 15, wherein during hitching, the support spindle and the at least one jaw constitute an articulation pivoting along the third substantially horizontal pivoting axis directed transversely to the direction of travel.

28. An agricultural machine as claimed in claim 15, wherein the agricultural machine is a mower.
